(19) United States
(12) Patent Application Publication
(10) Pub. No.: US 2015/0054633 A1
(43) Pub. Date: Feb. 26, 2015

(54) Interactive Tangible Interface for Hand Motion

(71) Applicant: New York University, New York, NY (US)

(72) Inventors: Abdulmotaleb El Saddik, Ottawa (CA); Ali Karime, Ottawa (CA); Nikolaos Giakoumidis, Athens (GR)

(73) Assignee: New York University, New York, NY (US)

(21) Appl. No.: 14/466,383

(22) Filed: Aug. 22, 2014

Related U.S. Application Data
(60) Provisional application No. 61/869,553, filed on Aug. 23, 2013.

(51) Int. Cl. G06F 3/01; G08B 6/00

(52) U.S. Cl. CPC G06F 3/016; G08B 6/00
USPC 340/407.1

(57) ABSTRACT

Methods, systems, and apparatuses, including computer programs encoded on computer-readable media are disclosed, for receiving, from an inertial measurement unit (IMU) the motion information of an interactive digital stress ball device and from the force detection sensors the pressure information exerted on each of the sensors attached on the ball surface. A haptic actuator and a haptic simulator are used to generate haptic feedback. The sensory analog signals are converted to digital signals and feed into the kinematic computation to calculate performance metrics. Sensory data is transmitted wirelessly to other digital entities. The interactive digital stress ball can also receive digital commands through wireless communication for the generation of the haptic feedback. The electronically embedded stress ball is able to track the motion of the hand and wirelessly transmit a set of kinematics that can be used to control computer games and other peripheral devices.

### CROSS-REFERENCE TO RELATED APPLICATIONS

This application claims priority to U.S. Provisional App. No. 61/869,553, filed Aug. 23, 2013, which is hereby incorporated by reference in its entirety.

### BACKGROUND

Interactive interface controller devices (IICDs) have gained increased popularity in everyday lives of the consumers. Examples of IICDs include computer game controllers, motion sensitive controller, remote controller and keyboard controller, etc. Yet, many of the existing devices are not intuitive and easy to grasp and handle or difficult to communicate data with other systems. For the majority of existing IICD software applications, the primary means of interaction with an IICD is through the direct touch or movement. Haptic-feedback, however, is missing.

### SUMMARY

One implementation, relates to an interactive digital device comprised of the following parts: (1) a housing, (2) an Inertial Measurement Unit (IMU) for detecting the motion information, (3) force sensors for measuring the pressure of each of the 5 hand fingers, (4) a haptic actuator for providing a haptic feedback, (5) a microcontroller for processing the signals, (6) a wireless communication chip for transmitting and receiving the data to and from other peripheral devices, and (7) a USB rechargeable battery for powering the circuit.

In general one implementation of the subject matter described in this specification can be embodied in methods for receiving, from the Inertial Measurement Unit and the Force Sensors, motion and pressure information of a device. The microcontroller is used to acquire and process data and provide information to the wireless communication module. The wireless communication module ensures a bidirectional communication between the interactive digital stress ball and the peripheral device in vicinity. The actuator is used to provide haptic feedback that might be required by some particular application.

In one implementation, the current pressure and position is used to evaluate the hand motion of a patient during a rehabilitation task. In another implementation, the current pressure and position is used to provide gaming controlling information. In some other embodiments, this device can be used as an intelligent tangible interface to control the ambient intelligent environment or authenticate users by measuring interaction dynamics. Other implementations of this aspect include corresponding systems, apparatuses, and computer-readable media.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 illustrates the outer surface of the interactive digital stress ball device in accordance with an illustrative implementation.

FIG. 2 illustrates the various components embedded inside the interactive digital stress ball device in accordance with an illustrative implementation.

FIG. 3 illustrates the underlying software architecture used by the interactive digital stress ball device in accordance with an illustrative implementation.

FIG. 4 illustrates a system including a processing/computing arrangement in accordance with an illustrative implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

The conventional interactive interface controller devices (IICDs) generally lack an important feature: haptic force-feedback. This friction-based feedback plays an essential role in most human-machine interaction scenarios, whether when driving an automobile (steering, stepping on the accelerator), typing on the keyboard, or when playing traditional musical instruments (guitars, pianos, percussion instruments, etc.). The absence of force-feedback can diminish user control and interaction expressivity whether in the context of a gaming environment, musical instrument application, or when engaging with something simple as an Internet browser. As described herein, haptic-feedback can be provided to a user of an interactive digital stress ball, a user input computing device utilizing elastic material such as foam silicone plastic.

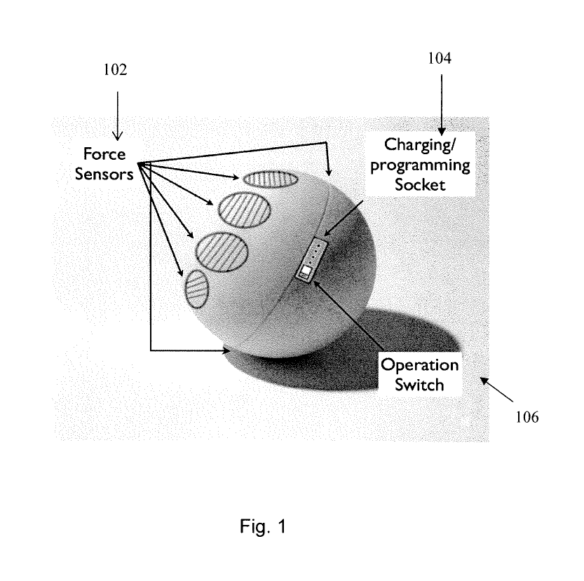

One implementation of the present invention is illustrated in FIG. 1. FIG. 1 illustrates a haptic device having a housing with an outer surface and an interior. As seen in FIG. 1, the device is ball-shaped, substantially spherical in this implementation, but the device may be and ellipsoid, ovoid, or other three-dimensional shape. In one implementation, the shape is selected to allow for ease of grasping in a given application. In one implementation, the ball is composed of a deformable material, for example foam silicone plastic which enables the ball to be elastic and hence be adaptive to the palm's shape when it is squeezed by the user. The selection of the type of material may vary depending on the particular application, for example applications involving medical or rehabilitation may utilize a softer or more elastic material while gaming applications may utilize a more rigid or inelastic material. The primary consideration in selecting the material is that the device be compressible or deformable enough to allow a user to interact with or squeeze the device and experience force feedback through sensors.

In one implementation, two hemispheres can be securely affixed together to form one ball. The ball includes one or more force sensors 102. For example, in the implementation of FIG. 1, there are six force sensors 102 that attached on the outer layer of the ball which can detect the force exerted by each of the hand fingers. These sensors 102 would be positioned beneath the fingers when the ball is grabbed. In one embodiment, five sensors 102 are utilized. The sensors 102 maybe positioned to correspond to the placement of a hand on the ball. In one embodiment, the sensors 102 are positioned to correspond to a left-hand or right-hand configuration. In another embodiment, six sensors are provided, with two different sensors 102 being positioned for engaging the thumb of a different hand, thus allowing for an ambidextrous configuration.

A socket 104 can be placed on the side of the ball for both power charging and programming input. The power can be supplied via a USB port. An operation switch 106 can be located beside the charging/programming socket 104, such as to turn the device on or off.

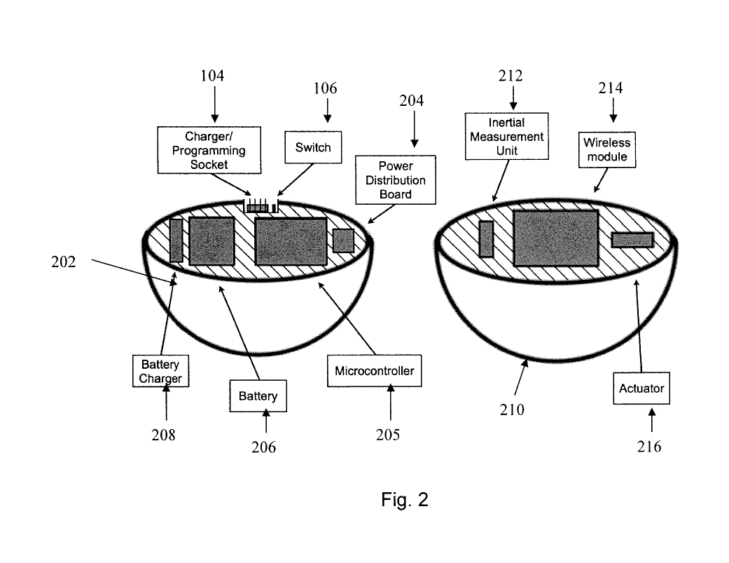

FIG. 2 illustrates the various components embedded inside the interactive digital stress ball device in accordance with an illustrative implementation. In one half of the ball device 202, the charging/programming socket 104 and operation switch 106 can be placed near the edge of the half ball planar surface. A power distribution board 204 can also be integrated in this half of the ball 202. The power distribution board 204 supplies the power for all the electronic components inside the ball device. A rechargeable battery 206 which provides the power to power distribution board 204. A battery charger component 208 can be place next to the battery 206.

The ball further includes a microcontroller (MC) 205, which can be placed beside the power distribution board 204. The microcontroller is used to acquire and process the data from various sensors and to provide information to a wireless communication module. The microcontroller 205 is in communication with various electronic components, in addition to the wireless communication module, including an Inertial Measurement Unit 212, a Force Detection Module 306 and a Haptics Simulator 308.

The Inertial Measurement Unit (IMU) 212 can be embedded in the second half of the ball 210. The IMU 212 is the component that senses the different accelerations, velocities and gravitational forces that are needed to determine the motion information of the hand. This component is used for detecting the motion of the hand on the x, y, and z coordinates. The IMU 212 might consist of a 3 axis accelerometer, gyroscope, magnetometer, any other motion detection device. The wireless communication module 214 can also be integrated in the same half of the ball 210. The wireless communication module 214 ensures a bidirectional communication between the intelligent stress ball and the peripheral device in vicinity. An actuator 216 can be located beside the wireless communication module 214 and be connected to the MC in order to provide the haptic feedback that might be required by a particular application in order the user for an event. It should be appreciated, the internal components of the device may be positioned in different arrangements as appropriate.

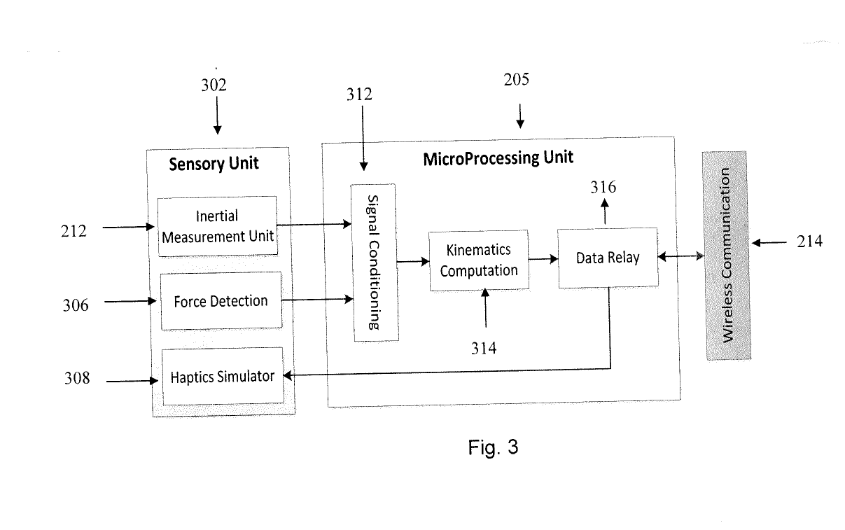

FIG. 3 illustrates the underlying software architecture used by the interactive digital stress ball device in accordance with an illustrative implementation. According to various implementations, the electronically embedded stress ball is able to track the motion of the hand and wirelessly transmit a set of kinematics that can be used to control computer games and other peripheral devices.

As seen in FIG. 3, a sensory unit 302 is provided that includes the Inertial Measurement Unit (IMU) 212, a Force Detection Module 306 and a Haptics Simulator 308. The output of IMU 212 is 6 degrees of freedom (DOF) captured information that consists of the translational movements on the x, y, and z axes and the three rotational movements on those axes called pitch, roll and yaw. The Force Detection module 306 generates information pertained to the forces applied on the ball. The Haptics Simulator 308 is responsible of generating the haptic feedback. It might consist of any low power DC vibration or pneumatic actuator. The behavior of the haptic simulation can be controlled using the Pulse Width Modulation (PWM) that can increase or decrease the intensity of the vibrations by properly tuning the frequency of the pulses and/or the duration of the triggering of the pulses. In one embodiment, a haptic funneling technique may be used.

The MicroProcessing Unit 205 can include a Signal Conditioning module 312, a Kinematics Computation module 314 and a Data relay module 316. The Signal Conditioning module 312 accomplishes the Analog to Digital conversion of the sensory signals and the proper filtration and calibration of the devices. Sensor devices produce analog signals that need to be quantized into discrete values so that they can be processed by the microcontroller. Most the Inertial devices are prone to noise that can alter their output readings. These readings are corrected by using a filtering algorithm, such as a Kalman filter that produces the best estimated values. Kinematics Computation module 314 receives the sensory digitized and calibrated data and first computes the main parameters which consist of the accelerations and the velocities on the three axes. Afterwards, other performance metrics such as the ranges of motions (pitch, roll, and Yaw), tremor, stress etc . . . can be calculated from the main parameters using a set of well-studied trigonometric and mathematical equations. Data Relay module 316 comprises a set of communication protocols that facilitate the transmission of the sensory data to other digital entities, and the reception of digital commands for the generation of the haptic feedback. Wireless Communication module 214 enables a portable free-space interaction with other digital entities (e.g. laptop, smartphone etc . . . ). It can be any wireless technology such as Bluetooth, ZigBee, among others.

In various implementations, the following four possible areas may attract potential consumer attentions: Active Biometrics, Ambient Intelligence Controller, Game Controller, and Rehabilitation.

For rehabilitation implementations, the ball can be used to evaluate the hand motion of the patient during a rehabilitation task that is recommended by the therapist. During the training the ball can transmit wirelessly the related motion information to the patient's computer, smartphone, or tablet which runs a special application that broadcasts the collected data, such as to the therapist's computer, smartphone, or tablet. The therapist can check the collected data and provide feedback on the training progress during the patient's next visit.

In another implementation, the ball can be used as a game controller. The ball can be used as an alternative to a gaming interface such as mouse, keyboard or joystick when playing a software game. In one example, it might be used as an intuitive interface to play a car racing computer game where the speed of the car is controlled through exerting more or less grip pressure on the ball and the orientation of the ball determines when the car turns right/left.

In another implementation, the ball can be used as an Ambient Intelligence Controller. The ball can be used as an intelligence tangible interface to control the ambient intelligent environment. For instance, in a smart home, the ball can be used as an intuitive switch device for turning on/off the lights in a room, television, air conditioner, etc.

In another implementation, active biometric strives to find new mechanisms to authenticate users by measuring interaction dynamics and has proven feasible to authenticate users. In one application, the ball can be used to detect biometric behavior to authenticate a user and/or grant access to computing resources.

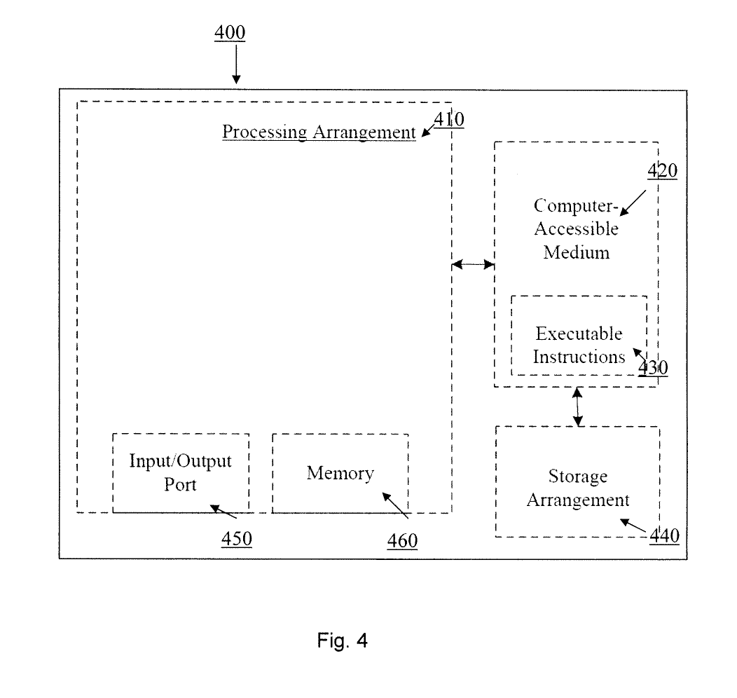

In one embodiment, shown in FIG. 4, a system 400 is provided. FIG. 4 shows an exemplary block diagram of an exemplary embodiment of a system 400 according to the present disclosure. For example, an exemplary procedure in accordance with the present disclosure can be performed by a processing arrangement 410 and/or a computing arrangement 410. Such processing/computing arrangement 410 can be, e.g., entirely or a part of, or include, but not limited to, a computer/processor that can include, e.g., one or more microprocessors, and use instructions stored on a computer-accessible medium (e.g., RAM, ROM, hard drive, or other storage device).

As shown in FIG. 4, e.g., a computer-accessible medium 420 (e.g., as described herein, a storage device such as a hard disk, floppy disk, memory stick, CD-ROM, RAM, ROM, etc., or a collection thereof) can be provided (e.g., in communication with the processing arrangement 410). The computer-accessible medium 420 may be a non-transitory computer-accessible medium. The computer-accessible medium 420 can contain executable instructions 430 thereon. In addition or alternatively, a storage arrangement 440 can be provided separately from the computer-accessible medium 420, which can provide the instructions to the processing arrangement 410 so as to configure the processing arrangement to execute certain exemplary procedures, processes and methods, as described herein, for example.

System 400 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalent.

What is claimed is:

1. A haptic device comprising:
a housing configured conform to a user's hand; and
at least one force sensor configured to measure the pressure exerted by at least one figure of a user's hand on the exterior portion of the housing;
a microcontroller disposed within the housing and in communication with:
an inertial measurement unit (IMU) disposed within the ball configured to detect motion of the housing; and
a haptic actuator for providing a haptic feedback; and
a wireless communication module for transmitting and receiving data to and from other peripheral devices.

2. The system of claim 1, wherein the housing is an elastic ball.

3. The system of claim 2, wherein the at least one sensor comprises six sensors associated with six corresponding sensors locations spaced about the exterior of the ball to allow for placement of a user's hand on the six sensors locations and further wherein, each haptic actuator associated with one of the six sensor the haptic actuator comprises six haptic actuators locations.

4. The system of claim 2, wherein the elastic ball further comprises foam silicone plastic which is elastic and can be squeezed by the human hand.

5. The system of claim 2, where the inertial measurement unit (IMU) is further configured to sense the different accelerations, velocities and gravitational forces to determine the motion information of the hand.

6. The system of claim 5, where the inertial measurement unit (IMU) is further configured to detect the motion of the translational movements on the x, y, and z coordinates.

7. The system of claim 5, where the inertial measurement unit (IMU) is further configured to detect the motion of the three rotational movements on axes called pitch, roll and yaw.

8. The system of claim 1, where the inertial measurement unit (IMU) further comprises a 3 axis accelerometer, gyroscope, magnetometer, any other motion detection device.

9. The system of claim 2, wherein the haptic actuator is associated with the exterior surface of the ball to provide haptic feedback to a user's hand positioned to interact with the at least one sensor.

10. The system of claim 1, wherein the microcontroller is further configured to:
acquire and process data from various sensors; and
provide useful information to the wireless communication module.

11. The system of claim 1, wherein the wireless communication module is further configured to interact with other digital entities using wireless technology.

12. A method comprising:
receiving, from an inertial measurement unit (IMU) the motion information of a ball shaped device; and
receiving, from the force detection sensors the pressure information exerted on each of the sensors; and
simulating and generating haptic feedback; and
conditioning signal to convert sensory analog signals to digital signals; and
calculating kinematic performance metrics; and
transmitting sensory data to other digital entities and receiving digital commands for generating the haptic feedback.

13. The method of claim 12, further comprising sending information to and from other digital devices by using wireless technology.

14. The method of claim 12, wherein simulating and generating haptic feedback further comprises using any low power DC vibration or pneumatic actuator.

15. The method of claim 14, further comprising controlling the haptic simulation using the Pulse Width Modulation (PWM) that can increase or decrease the intensity of the vibrations by properly tuning the frequency of the pulses.

16. The method of claim 12, wherein conditioning signal further comprises proper filtration and calibration to produce discrete digital values from analog signals.

17. The method of claim 16, further comprising using a filtering algorithm to produce best estimated digital values.

18. The method of claim 12, wherein computing kinematics is configured to receive sensory digitized and calibrated data; and
first compute the acceleration and the velocity main parameters on the three axes; and
then calculate performance metrics comprising the ranges of motions, tremor and stress from the main parameters.

19. A non-transitory computer-readable memory having instructions stored thereon, the instructions comprising:
instructions for receiving, from an inertial measurement unit (IMU) the motion information of a device; and
instructions for receiving, from the force detection sensors the pressure information exerted on each of the sensors; and
instructions for simulating and generating haptic feedback; and
instructions for converting sensory analog signals to digital signals; and
instructions for computing kinematic performance metrics; and
instructions for transmitting sensory data to other digital entities and receiving digital commands for generating the haptic feedback.
